(19) United States
(12) Patent Application Publication
(10) Pub. No.: US 2020/0003264 A1
(43) Pub. Date: Jan. 2, 2020

(54) GEAR ARRANGEMENT HAVING AN OVERLOAD CLUTCH AND AN ELECTRIC MOTOR-DRIVABLE DRIVE TRAIN

(71) Applicant: Schaeffler Technologies AG & Co. KG, Herzogenaurach (DE)

(72) Inventors: Stefan Lenßen, Bühl (DE); Michael Metz, Forbach (DE)

(73) Assignee: Schaeffler Technologies AG & Co. KG, Herzogenaurach (DE)

(21) Appl. No.: 16/465,189

(22) PCT Filed: Nov. 23, 2017
(86) PCT No.: PCT/DE2017/101011

§ 371 Date: May 30, 2019

(30) Foreign Application Priority Data
Dec. 13, 2016 (DE) 102016124126.1

(51) Int. Cl. F16D 7/02; F16H 55/17; B60K 17/02; F16H 55/22; F16H 35/10; F16D 43/21

(52) U.S. Cl. CPC F16D 7/021; F16H 55/17; B60K 17/02; F16H 2055/178; F16H 35/10; F16D 43/211; F16H 55/22

(57) ABSTRACT

A gearwheel arrangement for a drive train of a motor vehicle includes a drive shaft, a gearwheel, and a slipping clutch. The gearwheel is seated on the drive shaft and includes a toothing system. The slipping clutch is disposed at a point on the gearwheel between the toothing system and the drive shaft. The slipping clutch opens if a limit torque to be transmitted between the drive shaft and the toothing system is exceeded. In an example embodiment, the slipping clutch has a shaft/hub connection with a shaft region and a hub region, and the shaft region is seated via a press fit on the hub region.

### CROSS-REFERENCE TO RELATED APPLICATIONS

This application is the United States National Phase of PCT Appln. No. PCT/DE2017/101011 filed Nov. 23, 2017, which claims priority to German Application No. DE102016124126.1 filed Dec. 13, 2016, the entire disclosures of which are incorporated by reference herein.

### TECHNICAL FIELD

The disclosure relates to a gearwheel arrangement for a drive train (having an electric machine, for example) of a motor vehicle, such as a passenger car, bus, truck or another commercial vehicle, having a drive shaft and a gearwheel which is seated on the drive shaft. The disclosure also relates to a drive train, e.g., a hybrid drive train, for a motor vehicle, having an electric machine and a gearwheel arrangement which is coupled or can be coupled to the electric machine.

### BACKGROUND

In the case of drive trains which are driven purely by an internal combustion engine, numerous methods are already known, in order to damp torque peaks which are introduced into the drive train, for instance, by way of an internal combustion engine and/or by way of the shifting behavior of the driver. In this context, DE 10 2015 200 846 A1 discloses a torque transmission device for a drive train, having an input part, an output part, and a slipping clutch which is arranged between the input part and the output part, the slipping clutch being formed from a press-press soldered connection.

There is the disadvantage, in particular, in the case of hybrid drive trains which have been used increasingly up to now, however, that relatively high torque peaks can occur in the torque flow between the electric machine of the drive train and the tires of the motor vehicle, which torque peaks can be damped merely relatively poorly by way of the existing elements, for instance the transmission. Damage to the electric machine can be the consequence.

### SUMMARY

The disclosure teaches a slipping clutch which opens if a limit torque which is to be transmitted between the drive shaft and a toothing system of the gearwheel is exceeded disposed at a point on the gearwheel, which point is situated between the toothing system and the drive shaft. Below the limit torque or until the limit torque is reached, the slipping clutch may be closed permanently/over the entire torque range.

As a result, a protective measure for the drive train is implemented. The high-energy peaks which are caused by way of the electric machine and can grow during operation to more than 2 kJ (in comparison with a drive train which is driven purely by internal combustion engine at a maximum of 500 J) are effectively cut off and are not transmitted further in the drive train. The slipping clutch therefore configures an impact protection means in the gearwheel arrangement.

If the slipping clutch has a shaft/hub connection or the slipping clutch is configured by way of a shaft/hub connection, a shaft region of the shaft/hub connection being seated via a press fit on a hub region of the shaft/hub connection, the slipping clutch is of particularly space-saving configuration.

In this regard, an integrally joined connecting layer may be arranged between the shaft region and the hub region. As a result, a press-press soldered connection in the form of the shaft/hub connection is integrated into the gearwheel arrangement.

In this regard, the connecting layer may be applied on the shaft region or on the hub region before the assembly of the shaft/hub connection. As an alternative, the connecting layer may have a (first) connecting part layer which is applied on the shaft region (before the assembly of the shaft/hub connection), and/or a (second) connecting part layer which is applied on the hub region (before the assembly of the shaft/hub connection). As an alternative to this, it is in turn possible to even configure the connecting layer in the form of a sleeve and to arrange the sleeve (during the assembly of the shaft/hub connection) between the hub region and the shaft region. As a result, it is possible to set a thickness of the connecting layer in a variable manner.

The connecting layer may consist of a soft metal such that the connecting layer is a soft metal layer.

An axial securing device which secures the shaft region relative to the hub region in the axial direction may provide a durable bond of the shaft/hub connection.

The toothing system may be configured as a helical toothing system and the axial securing device then reliably supports the axial forces which are brought about on the gearwheel.

The slipping clutch may lie in the radial direction outside a diameter which is half as large as a pitch circle diameter of the toothing system so that high torques can be implemented by way of the slipping clutch. In order to generate less high torques by way of the slipping clutch and to therefore trigger the slipping clutch at an earlier time, the slipping clutch may be placed in the radial direction within a diameter which is half as large as a pitch circle diameter of the toothing system.

Furthermore, the slipping clutch may be arranged in the radial direction between the drive shaft and the gearwheel. Here, the slipping clutch may be seated between an outer circumferential face of the drive shaft and an inner circumferential face of the gearwheel. As a result, the constituent parts of the gearwheel arrangement are of simple construction.

Furthermore, the gearwheel may be of multiple-piece configuration, and the slipping clutch may be arranged in the radial direction between an outer ring section which has the toothing system and an inner section of the gearwheel, which inner section is connected fixedly to the drive shaft so as to rotate with it. This results in a variable positioning possibility of the slipping clutch in the radial direction.

The slipping clutch may be sealed toward a surrounding area of the gearwheel and/or the drive shaft to be protected against lubricants which surround the gearwheel and the drive shaft, such as oil. The oil can surround the gearwheel and the drive shaft in the form of oil mist, sprayed oil or even as an oil sump. In this way, no oil or any other lubricant creeps into the slipping clutch.

The slipping clutch may be sealed toward the surrounding area on a first axial side and/or a second axial side which lies opposite the first axial side by means of a sealing ring, such as an O-ring or a shaft sealing ring, a slide ring seal or a gap seal.

Furthermore, the disclosure relates to a (hybrid) drive train for a motor vehicle having an electric machine and a gearwheel arrangement as described above, which is coupled or can be coupled to the electric machine.

The gear arrangement may be arranged in the drive train between the electric machine and an output shaft. The output shaft may directly configure the drive shaft. As an alternative, the tooth arrangement may be arranged directly on an output shaft of the electric machine, the output shaft then also directly configuring the drive shaft, and the gearwheel coupling the electric machine further to a transmission.

In other words, an overload coupling which is integrated into the gearwheel may be implemented in this way to damp high energy shocks. According to the disclosure, a press-press soldered combination may be implemented as a shaft/hub connection, in which the press-press soldered connection is arranged between gearwheel and a shaft (drive shaft). The press-press soldered connection can be arranged close to the toothing system of the gearwheel, in order to achieve a high limit torque, at which the slipping clutch slips, or can be arranged close to the drive shaft, in order to already implement slipping of the slipping clutch at low torque values. The press-press soldered connection may be realized in a drive train between an electric machine and an output shaft, for example directly on an output shaft of the electric machine and a gearwheel which connects the electric machine to the transmission. A sealing means may be implemented at the press-press soldered connection, in order to seal the press-press soldered connection from the surrounding area.

### BRIEF DESCRIPTION OF THE DRAWINGS

The invention will now be described in greater detail using figures, in which context different exemplary embodiments are also described.

In the figures:

FIG. 1 shows a longitudinal sectional illustration of a gearwheel arrangement according to the invention in accordance with a first exemplary embodiment, the gearwheel arrangement having a gearwheel, a drive shaft and a slipping clutch, and the slipping clutch being arranged in the radial direction between the drive shaft and the gearwheel,

FIG. 2 shows a longitudinal sectional illustration of a gearwheel arrangement according to the invention in accordance with a second exemplary embodiment, the slipping clutch being integrated into a split gearwheel,

FIG. 3 shows a longitudinal sectional illustration of a gearwheel arrangement according to the invention in accordance with a third exemplary embodiment, the slipping clutch once again being arranged (in a similar manner to FIG. 1) between the drive shaft and the gearwheel, and now additionally being sealed toward the surrounding area by means of two seals which are configured as O-rings, and

FIG. 4 shows a longitudinal sectional illustration of the gearwheel arrangement according to the invention in accordance with a fourth exemplary embodiment, the slipping clutch once again (in a similar manner to FIG. 2) being integrated into a split gearwheel, and now additionally being sealed toward the surrounding area via a shaft sealing ring and a gap seal.

The figures are merely diagrammatic in nature and serve for the comprehension of the disclosure. The same elements are provided with the same designations. The various features of the different exemplary embodiments can also be combined freely with one another.

### DETAILED DESCRIPTION

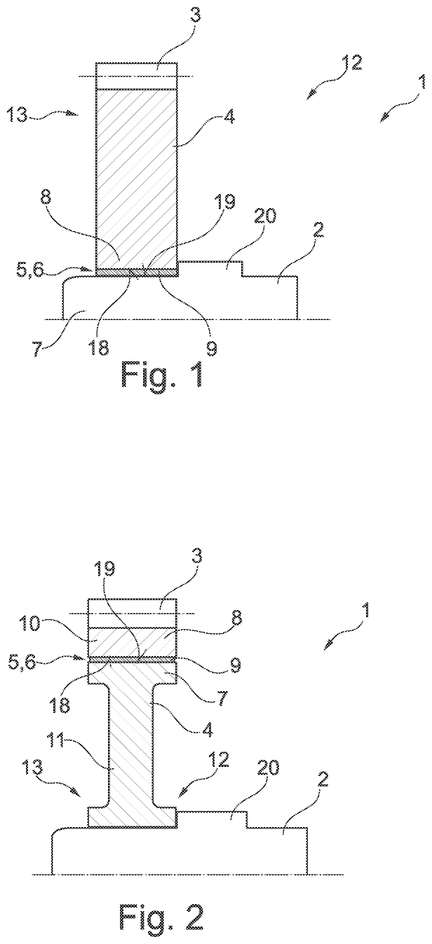

The principal construction of a gearwheel arrangement 1 according to the disclosure can be seen particularly clearly in FIG. 1. The gearwheel arrangement 1 may be part of a transmission apparatus/transmission (not shown further here for the sake of clarity), and can therefore also be called a transmission apparatus as an alternative. The gearwheel arrangement 1 has a drive shaft 2 and a gearwheel 4 which is arranged fixedly on the drive shaft 2 so as to rotate with it. In principle, the drive shaft 2 can be configured as a transmission shaft, for instance a transmission input shaft or a transmission output shaft, of a transmission of a hybrid or purely electric drive train, but is already a direct/materially integral constituent part of an output shaft/drive shaft of an electric machine of the drive train in this exemplary embodiment. The gearwheel arrangement 1 may be used in the torque flow between the electric machine and the transmission/manual transmission of the drive train.

According to the disclosure, a slipping clutch 5 is used at a point between a toothing system 3 (in the form of an external toothing system) of the gearwheel 4 and the drive shaft 2 in such a way that it opens if a limit torque which is to be transmitted between the drive shaft 2 and the toothing system 3 is exceeded. The slipping clutch 1 is therefore designed as an overload coupling and opens if the limit torque which is predefined by way of the nature of the slipping clutch 1 is exceeded. Below said limit torque, the gearwheel 4 is connected fixedly (as depicted in FIG. 1) via the slipping clutch 5 to the drive shaft 2 so as to rotate with the latter. Therefore, the drive shaft 2 is connected fixedly to the gearwheel 4 by way of the closed slipping clutch 5 below the limit torque or until the limit torque is reached.

The slipping clutch 5 is provided in the form of a shaft/hub connection 6. The drive shaft 2 directly configures a shaft region 7 of the shaft/hub connection 6, whereas a hub region 8 of the shaft/hub connection 6 is configured directly by way of the gearwheel 4. As a consequence, the shaft/hub connection 6 is configured between an inner circumferential side 18/inner circumferential face (hub region 8) of the gearwheel 4 and an outer circumferential side 19/outer circumferential face (shaft region 7) of the drive shaft 2. The shaft region 7 and the hub region 8 are adapted to one another in a tolerance-related manner in such a way that they are connected fixedly to one another via a press fit so as to rotate together.

In addition, a connecting layer 9 in the form of a soft metal layer is provided in the shaft/hub connection 6. Said connecting layer 9 is an integrally joined connecting layer 9 and serves, in addition to the (tolerance-related) press fit of the shaft/hub connection 6, to connect the shaft region 7 to the hub region 8 in an integrally joined manner. In this way, a press-press soldered connection is implemented by way of the shaft/hub connection 6.

The connecting layer 9 can in principle once again be of different configuration. Firstly, the connecting layer 9 can consist exclusively of a single connecting layer which is first of all attached to the gearwheel 4 and additionally connects the drive shaft 2 to the gearwheel 4 after assembly with the drive shaft 2. As an alternative to this, however, the connecting layer 9 can also be arranged exclusively on the drive shaft 2. In addition, the connecting layer 9 can in principle consist of a sleeve which is inserted between the two constituent parts. It is also possible to attach both a (first) connecting part layer to the shaft region 7 and a (second) connecting part layer to the hub region 8. In this way, the slipping clutch 5 functions in accordance with the press-press soldered connection which is described in DE 10 2015 200 846 A1, for which reason the further embodiment of said press-press soldered connection is considered to be integrated herein.

The slipping clutch 5 therefore opens firstly in a manner which is dependent on the binding force which is implemented by way of the press fit and also in a manner which is dependent on the material binding force/adhesion force which is realized by way of the integrally joined connecting layer 9. Said binding forces finally determine the limit torque, in the case of the exceeding of which opening of the slipping clutch 5 occurs.

As can also be seen clearly in FIG. 1, the gearwheel 4 is supported on a shoulder 20 on the drive shaft 2 toward a first axial side 12.

Shaft region 7 and the hub region 8 are secured against movement/displacement in the axial direction via an axial securing device which is not shown in greater detail here for the sake of clarity. In this context, the toothing system 3 may be configured as a helical toothing system. As an alternative, the toothing system 3 can be implemented as a spur toothing system or as other toothing system types.

Furthermore, it can be seen that the slipping clutch 5 in the first exemplary embodiment in accordance with FIG. 1 lies within a diameter (as viewed in the radial direction) which is half as large as a pitch circle diameter of the toothing system 3. As a result, the gearwheel arrangement 1 in accordance with FIG. 1 is provided for applications which already require relatively early opening of the slipping clutch 5 at relatively low limit torques.

It can be seen in conjunction with FIG. 2 that the slipping clutch 5 can also be arranged, however, outside a diameter which is half as large as a pitch circle diameter of the toothing system 3. The gearwheel arrangement 1 of the second exemplary embodiment is in principle constructed and functions in the same way as that of the first exemplary embodiment. Therefore, merely the differences between the exemplary embodiments will be discussed in the following text. In order to offset the slipping clutch 5 further radially to the outside in comparison with the configuration of the first exemplary embodiment and therefore to achieve a higher limit torque, the gearwheel 4 in accordance with FIG. 2 is split. A first part is implemented as an outer ring section 10 and directly has the toothing system 3. An inner section 11 of the gearwheel 4 is in turn permanently placed fixedly on the drive shaft 2 so as to rotate with it, and is arranged radially within the outer ring section 10. The slipping clutch 5 is integrated in the radial direction between the two sections 10 and 11. The slipping clutch 5 per se is implemented in a manner which corresponds to the slipping clutch 5 in accordance with FIG. 1, the shaft region 7 of the shaft/hub connection 6 then being implemented by way of the inner section 11/by way of the outer circumferential side 19 of the inner section 11, and the hub region 8 of the shaft/hub connection 6 being implemented by way of the outer ring section 10/by way of the inner circumferential side 18 of the inner section 11.

In order to arrange the slipping clutch 5/the shaft/hub connection 6 on a desired diameter, thick-walled sleeves can in principle also be used. Said sleeves can in principle be used additionally in the shaft/hub connection 6 or at another point.

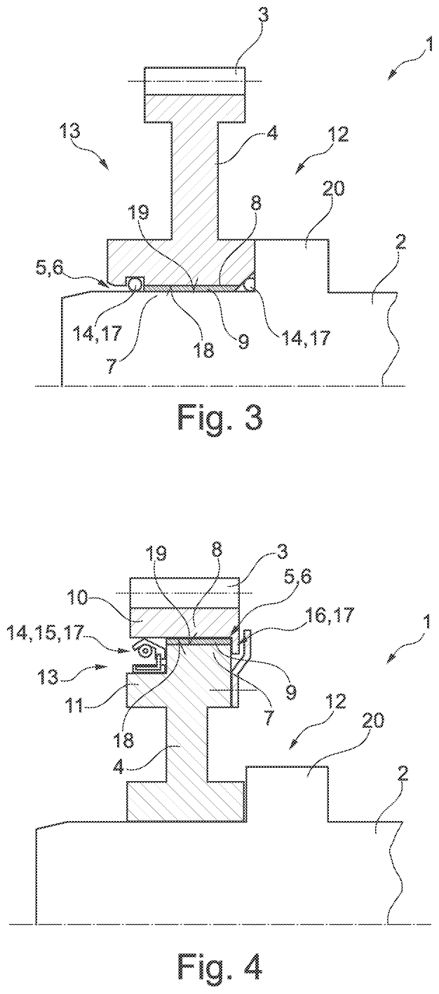

It can also be seen in conjunction with FIG. 3 that slipping clutch 5 is sealed toward the surroundings of the gearwheel 4 and the drive shaft 2. To this end, two seals 17 which are both implemented as sealing rings 14, namely O-rings, are used in FIG. 3 toward a first axial side and toward a second axial side of the gearwheel 4. O-rings may be advantageous in this context since it does not occur very frequently during operation of the tooth arrangement 1 that the slipping clutch 5 opens and therefore the gearwheel 4 rotates relative to the drive shaft 2. The further embodiment of the gearwheel arrangement 1 of the third exemplary embodiment is in principle constructed and functions in the same way as that of the first exemplary embodiment.

As an alternative, as shown in conjunction with FIG. 4, it is also possible, however, to seal the slipping clutch 5 (here, using the split gearwheel 4) toward the surrounding area by way of seals 17 of different configuration. A gap seal 16 is implemented toward a first axial side 12 of the gearwheel 4, which gap seal 16 at the same time defines an axial stop between the two sections 10 and 11. Toward a second axial side 13 of the gearwheel 4, the slipping clutch 5 is sealed toward the surrounding area by means of a shaft sealing ring 15. The further embodiment of the gearwheel arrangement 1 of the fourth exemplary embodiment is in principle constructed and functions in the same way as that of the second exemplary embodiment.

In addition, it is to be noted that, as an alternative to the seals 17 which are shown in FIG. 3 and FIG. 4, the seals can be configured in another way and different combinations of seals 14 can be realized. The individual seals 17 can be replaced by different sealing rings, such as O-rings or shaft sealing rings, slide ring seals or gap seals.

In other words, a press-press soldered connection is implemented in accordance with the disclosure, which connection is constructed in the form of a shaft/hub connection 6, the press-press soldered connection being arranged between a toothing system 3 and a shaft 2. In the present embodiments, an overload coupling is therefore implemented as a press-press soldered connection. In principle, the reason for the rise in the impact energies in the case of electrified or hybridized drive trains lies in the considerably higher mass inertias which are produced via the electric machine. In the case of said drive trains, the electric machine is coupled in a very rigid manner (without damping elements) to the transmission output shaft. For this reason, the inertia of a rotor of the electric machine (stepped up greatly on account of the transmission) acts as it were as a hard stop in the case of a torque surge. A torque surge or impact of this type can be initiated, for example, by way of a parking lock. Said parking locks usually do not first latch at a standstill of the motor vehicle, but rather also already at relatively low speeds. In the case of a drive by internal combustion engine, said surge is dissipated via the softnesses in the drive train. This is possible only to a very limited extent in the case of an electric or hybrid drive, with the result that an additional protective coupling becomes necessary which protects the components in the case of overloading.

In contrast to known protective couplings between the internal combustion engine and the transmission, the energy is considerably greater which has to be dissipated by the overload coupling in the case of the abovementioned area of use of electrified drive trains. On account of the high rigidity, substantially less energy can be buffer-stored in elasticities, with the result that the protective coupling also has to dissipate energies above 500 J multiple times without being damaged. This requirement is met by the press-press soldered connection, as has been proven in tests. Results of a test series, in the case of which the introduced energy has been increased to over 2 kJ, show that said 2 kJ itself is not the limit for the geometry which is used. Via a geometric adaptation of the slipping clutch 5, the energy which can be dissipated can be varied. This is implemented according to the invention by way of the arrangement of the slipping clutch 5 in the gearwheel arrangement 1.

Here, the press-press soldered connection can either be attached close below the toothing system 3 in the case of a diameter of greater than 50% of the pitch circle diameter (FIG. 2) if the slipping torque is to be high, or can be arranged close to the shaft 2 in the case of a diameter of less than 50% of the pitch circle diameter (FIG. 1) if the overload protection means is to already trigger at low torques. In some circumstances, it can be advantageous to use an additional thick-walled sleeve, in order for it to be possible for the press-press soldered connection to be positioned at the desired diameter.

The impact protection coupling (slipping clutch 5) may be situated in a transmission between the electric machine and the output shaft. For example, the clutch 5 can be situated directly on the electric motor shaft and the gearwheel 4, via which the electric motor engages into the vehicle transmission.

In a manner which is dependent on the precise installation location, the press-press soldered connection is subjected to oil in the form of oil mist, sprayed oil or even such that it dips into oil. In order to prevent oil or other lubricants from creeping into the press-press soldered connection, it is advantageous the latter may be sealed. This can take place by means of O-rings which seal the slipping clutch on one side or on both sides (FIG. 3). On account of the relatively low number of impacts over the service life, in the case of which impacts a rotation of the shaft 7 with respect to the hub 8 occurs, O-rings are sufficient as a sealing element. It goes without saying that other known possibilities for the sealing of rotating components (with or without a relative movement), such as shaft sealing rings 15, slide ring seals, gap seals 16, etc., are also possible. For a protective coupling 5 close to the toothing system 3, by way of example, FIG. 4 shows how sealing is carried out on the one side via a shaft sealing ring 15 and on the second side via a gap (gap seal 16). The example in FIG. 4 is intended to show that any desired combination of different sealing elements (seals 17) are also possible if this is advantageous, for example, for reasons of installation space.

In the figures which are shown, the illustration of an axial securing means against the migration of the press-press soldered connection has been dispensed with. Tests have shown, however, that said axial securing means should be provided. Here, for example, a helical toothing system 3 is mentioned which generates axial forces which would lead in the case of slippage to the migration of the gearwheel 4. Further disturbance variables, such as vibrations or an inhomogeneous introduction of force, can also aid axial migration, however. The axial securing means is therefore present in the abovementioned case.

### REFERENCE NUMERALS

1 Gearwheel arrangement
2 Drive shaft
3 Toothing system
4 Gearwheel
5 Slipping clutch
6 Shaft/hub connection
7 Shaft region
8 Hub region
9 Connecting layer
10 Outer ring section
11 Main section
12 First side
13 Second side
14 Sealing ring
15 Shaft sealing ring
16 Gap seal
17 Seal
18 Inner circumferential side
19 Outer circumferential side

1.-10. (canceled)

11. A gearwheel arrangement for a drive train of a motor vehicle, comprising:
a drive shaft;
a gearwheel seated on the drive shaft and including a toothing system; and,
a slipping clutch that:
is disposed at a point on the gearwheel between the toothing system and the drive shaft; and,
opens if a limit torque to be transmitted between the drive shaft and the toothing system is exceeded.

12. The gearwheel arrangement of claim 11, wherein:
the slipping clutch comprises a shaft/hub connection;
the shaft/hub connection comprises a shaft region and a hub region; and,
the shaft region is seated via a press fit on the hub region.

13. The gearwheel arrangement of claim 12, further comprising an integrally joined connecting layer arranged between the shaft region and the hub region.

14. The gearwheel arrangement of claim 12, further comprising an axial securing device which secures the shaft region relative to the hub region in an axial direction.

15. The gearwheel arrangement of claim 11, wherein:
the toothing system comprises a pitch circle diameter; and,
the slipping clutch lies outside a diameter which is half as large as the pitch circle diameter.

16. The gearwheel arrangement of claim 11, wherein:
the toothing system comprises a pitch circle diameter; and,
the slipping clutch lies inside a diameter which is half as large as the pitch circle diameter.

17. The gearwheel arrangement of claim 11, wherein the slipping clutch is arranged radially between the drive shaft and the gearwheel.

18. The gearwheel arrangement of claim 11, wherein:
the gearwheel is of multiple-piece configuration with an outer ring section having the toothing system and an inner section;
the slipping clutch is arranged radially between the outer ring section and the inner section; and,
the inner section is connected fixedly to the drive shaft so as to rotate with it.

19. The gearwheel arrangement of claim 11, wherein the slipping clutch is sealed toward a surrounding area of the gearwheel or the drive shaft.

20. The gearwheel arrangement of claim 11 wherein the slipping clutch is sealed toward a first axial side or a second axial side which lies opposite the first axial side by a sealing ring selected from an O-ring, a shaft sealing ring, a slide ring seal or a gap seal.

21. A drive train for a motor vehicle comprising:
an electric machine; and,
the gearwheel arrangement of claim 11 which is coupled or can be coupled to the electric machine.

22. A gearwheel assembly for a vehicle drivetrain comprising:
a gearwheel comprising an external toothing system and an inner circumferential side;
a drive shaft comprising an outer circumferential side; and,
a soft metal connecting layer radially between the inner circumferential side and the outer circumferential side and forming a press-press soldered connection between the gearwheel and the drive shaft.

23. The gearwheel assembly of claim 22 wherein the soft metal connecting layer forms a slipping clutch and permits relative rotation between the gearwheel and the drive shaft when a predetermined torque limit is reached.

24. The gearwheel assembly of claim 22 wherein the gearwheel, the drive shaft, and the soft metal connecting layer form an overload coupling to limit a torque transfer between the gearwheel and the drive shaft, or vice-versa.

25. The gearwheel assembly of claim 22 wherein the drive shaft comprises a first radial face and the gearwheel comprises a second radial face in contact with the first radial face.

26. The gearwheel assembly of claim 25 wherein the gearwheel comprises a conical face connecting the inner circumferential side and the second radial face.

27. The gearwheel assembly of claim 26 further comprising an o-ring contacting the outer circumferential side, the first radial face, and the conical face.

28. The gearwheel assembly of claim 22 further comprising an o-ring, wherein gearwheel comprises a groove in the inner circumferential side and the o-ring is disposed in the groove.

29. The gearwheel assembly of claim 22 wherein the external toothing system is a helical gear.
